(19) United States
(12) Patent Application Publication
(10) Pub. No.: US 2017/0349213 A1
(43) Pub. Date: Dec. 7, 2017

(54) System And Method For Displaying A Forward Drive Trajectory, Providing A Jackknifing Warning And Providing A Trailer Turn Aid

(71) Applicant: GM Global Technology Operations LLC, Detroit, MI (US)

(72) Inventors: Akram M. ABDEL-RAHMAN, Ajax (CA); Ephraim C. YUEN, Markham (CA); Grant L. MEADE, Whitby (CA); Caroline CHUNG, Royal Oak, MI (US); Sepehr Pourrezaei Khaligh, North York (CA)

(21) Appl. No.: 15/279,523

(22) Filed: Sep. 29, 2016

Related U.S. Application Data
(60) Provisional application No. 62/344,740, filed on Jun. 2, 2016.

(51) Int. Cl. B62D 15/02; B62D 13/00; B62D 6/00

(52) U.S. Cl. CPC B62D 15/0295; B62D 15/025; B62D 6/003; B62D 13/00; B62D 15/021

(57) ABSTRACT

A system according to the principles of the present disclosure includes an expected trajectory module and an electronic display. The expected trajectory module determines an expected forward drive trajectory of a vehicle and determines an expected forward drive trajectory of a trailer being towed by the vehicle. The electronic display displays the expected forward drive trajectories of the vehicle and the trailer.

### CROSS-REFERENCE TO RELATED APPLICATIONS

This application claims the benefit of U.S. Provisional Application No. 62/334,740, filed on Jun. 3, 2016. The disclosure of the above application is incorporated herein by reference in its entirety.

### FIELD

The present disclosure relates to systems and methods for displaying a forward drive trajectory, providing a jackknifing warning and providing a trailer turn aid.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

When a vehicle towing a trailer makes a turn while moving forward, the trailer may follow a different path or trajectory than the path or trajectory that the vehicle follows. For a given turning radius of the vehicle, the difference between the trailer trajectory and the vehicle trajectory may be greater when the vehicle is travelling at low speeds relative to when the vehicle is travelling at high speeds. If a driver of the vehicle does not account for the difference between the trailer trajectory and the vehicle trajectory, the trailer may run over an outer lane boundary (e.g., a curb) extending alongside the road adjacent to the turn. If the driver overcompensates for the difference between the trailer trajectory and the vehicle trajectory, the vehicle may run over the centerline of the road onto which the vehicle is turning.

In some cases, the driver does not account for the difference between the trailer trajectory and the vehicle trajectory because the driver forgets that the vehicle is towing a trailer. In other cases, the driver is unable to comprehend the width of the trailer and/or the trajectory of the trailer.

### SUMMARY

A first example of a system according to the principles of the present disclosure includes an expected trajectory module and an electronic display. The expected trajectory module determines an expected forward drive trajectory of a vehicle and determines an expected forward drive trajectory of a trailer being towed by the vehicle. The electronic display displays the expected forward drive trajectories of the vehicle and the trailer.

A second example of a system according to the principles of the present disclosure includes an expected trajectory module, a target trajectory module, and at least one of a user interface device and a steering control module. The expected trajectory module determines an expected trajectory of a vehicle and determines an expected trajectory of a trailer being towed by the vehicle. The target trajectory module determines a target trajectory of the vehicle during a turn based on the expected vehicle trajectory, the expected trailer trajectory, and at least one road parameter. The user interface device guides a driver of the vehicle through the turn based on the target vehicle trajectory. The steering control module controls a steering actuator of the vehicle based on the target vehicle trajectory.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system according to the present disclosure, the vehicle system including a vehicle and a trailer being towed by the vehicle;

FIG. 2 is a functional block diagram of an example control system according to the present disclosure;

FIG. 3 is a flowchart illustrating an example method for displaying a forward drive trajectory of a vehicle and a trailer and providing a jackknifing warning according to the present disclosure;

FIGS. 4 through 7 are example images on an electronic display and an example graph displaying a forward drive trajectory of a vehicle and a trailer;

FIG. 8 includes example images on an electronic display displaying a forward drive trajectory of a vehicle and a trailer and providing a jackknifing warning according to the present disclosure;

FIG. 9 is a flowchart illustrating an example method for providing a turn aid for a driver of a vehicle towing a trailer according to the present disclosure;

FIGS. 10 through 14 are top views of an example vehicle system making a turn according to the present disclosure; and

FIGS. 15 and 16 include an example image on an electronic display and an example view of a driver of a vehicle towing a trailer illustrating a turn aid for the driver according to the present disclosure.

In the drawings, reference numbers may be reused to identify similar and/or identical elements.

### DETAILED DESCRIPTION

A system and method according to the present disclosure determines the trajectories of a vehicle and a trailer as the vehicle is moving forward through a turn and displays the trajectories in view of a driver of the vehicle. Thus, the driver may use the trajectories displayed to identify whether the trailer will run over an outer lane boundary or the vehicle will run over the centerline of the road onto which the vehicle is turning. In addition, the system and method may determine when jackknifing is likely to occur and display a jackknifing warning in view of the driver when jackknifing is likely to occur.

In various implementations, the system and method determines a target trajectory of the vehicle when the vehicle is about to make a turn and guides the driver through the turn based on the target vehicle trajectory. In one example, the system and method guides the driver through the turn by displaying a curve representing the target vehicle trajectory. In another example, the system and method determines a target steering wheel position based on the target vehicle trajectory and displays an arrow representing the target steering wheel position. The system and method may display the target vehicle trajectory and/or the target steering wheel position on an electronic display and/or a windshield of the vehicle.

Thus, in addition to informing the driver of a potential problem with the current vehicle trajectory, the system and method may provide a solution to that problem via the target vehicle trajectory. Further, in various implementations, the system and method controls a steering actuator to automatically steer the vehicle through a turn based on the target vehicle trajectory. When the vehicle steering is automatically controlled, the driver may continue to control the throttle of the vehicle and the brakes of the vehicle.

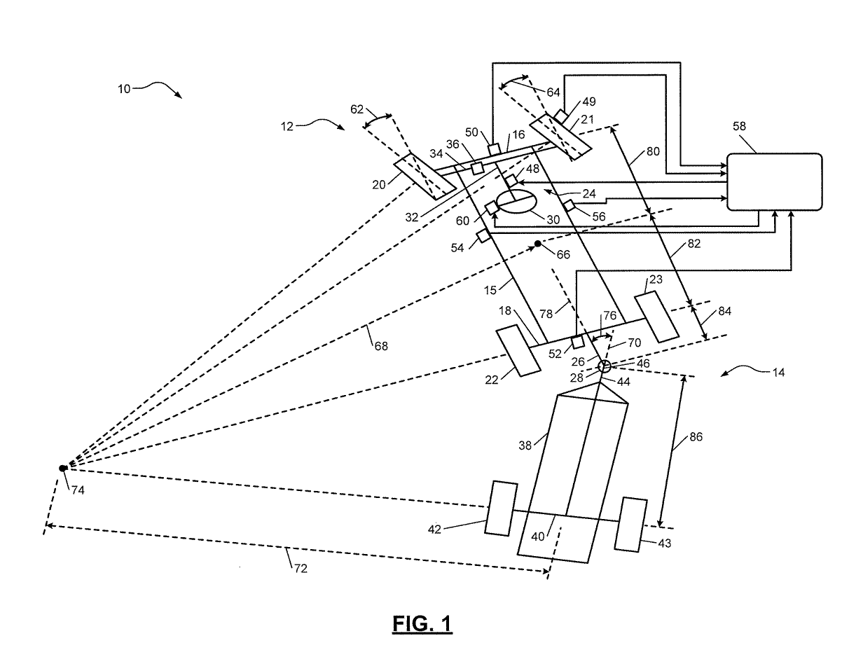

Referring now to FIG. 1, a vehicle system 10 includes a vehicle 12 and a trailer 14. The vehicle 12 includes a frame or body 15, a front axle 16, a rear axle 18, a left front wheel 20, a right front wheel 21, a left rear wheel 22, a right rear wheel 23, a steering system 24, and a trailer hitch 26 having a distal end or ball 28. The steering system 24 is operable to turn the left and right front wheels 20 and 21 and thereby turn the vehicle 12.

The steering system 24 includes a steering wheel 30, a steering column 32, a steering linkage 34, and a steering actuator 36. A driver rotates the steering wheel 30 to turn the vehicle 12 left or right. The steering column 32 is coupled to the steering wheel 30 so that the steering column 32 rotates when the steering wheel 30 is rotated. The steering column 32 may also be coupled to the steering linkage 34 so that rotation of the steering column 32 causes translation of the steering linkage 34. The steering linkage 34 is coupled to the left and right front wheels 20 and 21 so that translation of the steering linkage 34 turns the left and right front wheels 20 and 21.

The steering actuator 36 is coupled to the steering linkage 34 and is operable to translate the steering linkage 34 and thereby turn the left and right front wheels 20 and 21. The steering actuator 36 may be a hydraulic and/or electric actuator. If the steering column 32 is coupled to the steering linkage 34, the steering actuator 36 may reduce the amount of effort that the driver must exert to turn the vehicle 12 left or right. In various implementations, the steering column 32 may not be coupled to the steering linkage 34, and the steering actuator 36 may translate the steering linkage 34 in response to an electronic signal that is generated based on the position of the steering wheel 30. When the steering actuator 36 is electronically controlled in this way, the steering system 24 may be referred to as a steer-by-wire system.

The trailer 14 includes a frame or body 38, an axle 40, a left wheel 42, a right wheel 43, and a tongue 44 having a distal end 46. Although the trailer 14 is depicted as a two-wheel trailer, the principles of the present application apply to a trailer having more than two wheels. The distal end 46 of the tongue 44 may be placed onto the ball 28 of the trailer hitch 26 of the vehicle 12 to couple the trailer 14 to the vehicle 12.

The vehicle 12 further includes a steering angle sensor 48, a wheel speed sensor 49, a front camera 50, a rear camera 52, a left side camera 54, a right side camera 56, a control module 58, and a user interface device 60. The steering angle sensor 48 measures a steering angle of the vehicle 12 or another parameter that indicates the steering angle, such as the angular position of the steering column 32. The steering angle of the vehicle 12 may be an average value of a steering angle 62 of the left front wheel 20 and a steering angle 64 of the right front wheel 21. The steering angle sensor 48 may be mounted on the steering column 32 as shown or at another location in the steering system 24 between the steering wheel 30 and the left and right front wheels 20 and 21. The steering angle sensor 48 may include a Hall effect sensor.

The wheel speed sensor 49 measures the speed of a wheel of the vehicle 12. Although the wheel speed sensor 49 is shown mounted to the right front wheel 21 of the vehicle 12, the wheel speed sensor 49 may measure the speed of another wheel of the vehicle 12. In various implementations, the vehicle 12 may include multiple wheel speed sensors to measure the speeds of multiple wheels of the vehicle.

The front camera 50 captures an image of the environment in front of the vehicle 12. The rear camera 52 captures an image of the environment to the rear of the vehicle 12. The left side camera 54 captures an image of the environment on the left side of the vehicle 12. The right side camera 56 captures an image of the environment on the right side of the vehicle 12.

The control module 58 determines a forward drive trajectory of the vehicle 12 and a forward drive trajectory of the trailer 14 and controls the user interface device 60 to display the forward drive trajectories of the vehicle 12 and the trailer 14. In addition, the control module 58 determines when jackknifing is likely to occur, and controls the user interface device 60 to provide a jackknifing warning when jackknifing is likely to occur. Further, the control module 58 determines a target trajectory of the vehicle 12 when the vehicle 12 is about to make a turn and controls the user interface device 60 to display the target trajectory. In various implementations, the control module 58 may also control the steering actuator 36 based on the target trajectory of the vehicle 12.

The user interface device 60 may include an electronic display (e.g., a touch display) that displays the images captured by the cameras 50-56. In addition, the electronic display may display the forward drive trajectories of the vehicle 12 and the trailer 14 and/or the target trajectory of the vehicle 12, for example, as lines or curves that are overlaid onto the images captured by the cameras 50-56.

In addition to or instead of the electronic display, the user interface device 60 may include one or more vibrators mounted to, for example, the steering wheel 30 to provide haptic feedback to the driver regarding whether the vehicle 12 is following the target trajectory. For example, when the vehicle 12 is to the right of the target trajectory, the vibrators may vibrate the left side of the steering wheel 30 to direct the driver to turn the steering wheel 30 counterclockwise and thereby turn the vehicle 12 left. In another example, when the vehicle 12 is to the left of the target trajectory, the vibrators may vibrate the right side of the steering wheel 30 to direct the driver to turn the steering wheel 30 clockwise and thereby turn the vehicle 12 right.

The vehicle 12 has a mass center 66 that turns on a first circle having a radius 68, which is a function of the steering angle of the vehicle 12. The trailer 14 has a longitudinal centerline 70 that turns on a second circle having a radius 72. The first and second circles may have a common center at a point 74. The longitudinal centerline 70 of the trailer 14 is oriented at an angle 76 relative to a longitudinal centerline 78 of the vehicle 12. The angle 76 may be referred to as a hitch angle.

The mass center 66 of the vehicle 12 is located a distance 80 from the front axle 16 and a distance 82 from the rear axle 18. The ball 28 of the trailer hitch 26 is located a distance 84 from the rear axle 18. The axle 40 of the trailer 14 is located a distance 86 from the distal end 46 of the tongue 44 of the trailer 14.

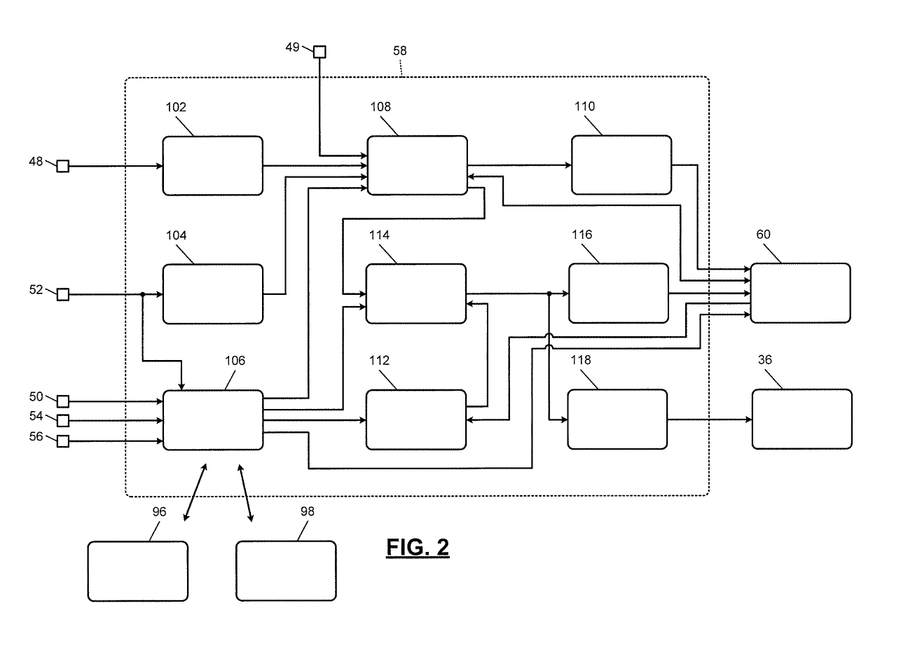

Referring now to FIG. 2, an example implementation of the control module 58 includes an actual steering angle module 102, a hitch angle module 104, an environment mapping module 106, an expected trajectory module 108, and a jackknifing identification module 110. The actual steering angle module 102 determines the actual steering angle of the vehicle 12 and outputs the actual steering angle. The actual steering angle module 102 may determine the steering angle of the vehicle 12 based on an input from the steering angle sensor 48.

In one example, the steering angle sensor 48 includes a first sensor that measures the steering angle 62 of the left front wheel 20 and a second sensor that measures the steering angle 64 of the right front wheel 21. The actual steering angle module 102 may determine the steering angle of the vehicle 12 based on the steering angles 62 and 64 of the left and right front wheels 20 and 21. For example, the actual steering angle module 102 may determine the steering angle of the vehicle 12 using a relationship such as

$$δ = {cot}^{- 1} ( \frac{cot {δ}_{1} + cot {δ}_{i} }{2} ) , \qquad ( 1 )$$

where δ is the steering angle of the vehicle 12, δₒ is the steering angle 62 of the left front wheel 20, and δᵢ is the steering angle of the right front wheel 21.

In another example, the steering angle sensor 48 measures the angular position of the steering column 32, and the actual steering angle module 102 determines the steering angle of the vehicle 12 based on the steering column position. In another example, the steering angle sensor 48 measures the angular position of the steering wheel 30, and the actual steering angle module 102 determines the steering angle of the vehicle 12 based on the steering wheel position.

The hitch angle module 104 determines the hitch angle (i.e., the angle 76 between the longitudinal centerline 70 of the trailer 14 and the longitudinal centerline 78 of the vehicle 12) and outputs the hitch angle. The hitch angle module 104 may determine the hitch angle based on an input from the rear camera 52, which may include an image of the environment to the rear of the vehicle 12. Additionally or alternatively, the hitch angle module 104 may determine the hitch angle based on an input from a Hall effect or ultrasonic sensor that measures the hitch angle.

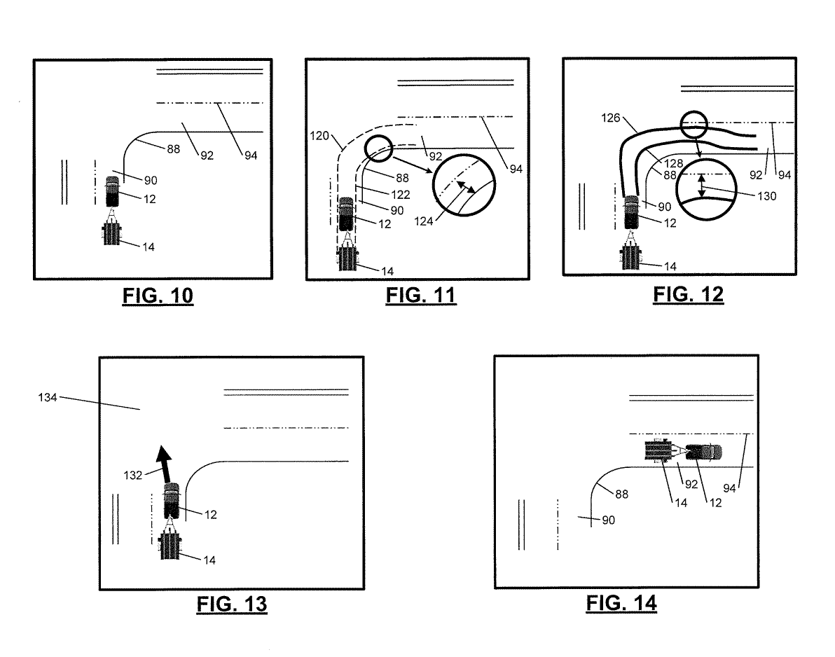

The environment mapping module 106 determines one or more parameters of a road on which the vehicle 12 is travelling, the position of the vehicle 12 on the road, and/or whether any obstacles lie in the expected trajectory of the vehicle 12. Briefly referring to FIG. 10, the road parameters may include an outer lane boundary 88 that extends alongside a first road 90 on which the vehicle 12 is currently travelling and a second road 92 onto which the vehicle 12 is turning. The outer lane boundary 88 may be a curb or a lane marking. The road parameters may also include a centerline 94 of the second road 92.

Referring again to FIG. 2, the environment mapping module 106 may determine the road parameters based on the image captured by the front camera 50. Additionally or alternatively, the environment mapping module 106 may receive the road parameters from a vehicle-to-everything (V2X) communication network 96 and/or a satellite communication network 98. The environment mapping module 106 may also determine the position of the vehicle 12 by communicating with the V2X communication network 96 and/or the satellite communication network 98. The environment mapping module 106 may include an antenna and/or a global positioning system (GPS) for wirelessly communicating with the V2X communication network 96 and/or the satellite communication network 98.

The environment mapping module 106 may determine whether any obstacles lie in the expected trajectory of the vehicle 12 based on the expected vehicle trajectory and the image captured by the front camera 50. Additionally or alternatively, the environment mapping module 106 may determine whether any obstacles lie in the expected trajectory of the vehicle 12 by communicating with the V2X communication network 96 and/or the satellite communication network 98.

In addition, the environment mapping module 106 may generate a top view of the vehicle 12 and at least part of the trailer 14 based on the images from the cameras 50-56. The environment mapping module 106 outputs the road parameters, the vehicle position, and/or the location of any obstacles that lie in the expected trajectory of the vehicle 12. Further, the environment mapping module 106 may generate one or more sets of gridlines representing the surface(s) of the first road on which the vehicle 12 is travelling and/or the second road onto which the vehicle 12 is turning. Each set of gridlines may correspond to one of the images captured by the cameras 50-56 or the top view generated by the environment mapping module 106. For example, a first set of gridlines may represent the road surface in the image captured by the front camera 50, and a second set of gridlines may represent the road surface in the top view.

The expected trajectory module 108 determines an expected trajectory of the vehicle 12 and an expected trajectory of the trailer 14. The expected trajectory module 108 outputs the expected trajectories of the vehicle 12 and the trailer 14. The expected vehicle trajectory may include one or more points and/or a curve representing a path through which one or more points on the vehicle 12 are expected to move. For example, the expected vehicle trajectory may include two curves representing the paths through which the left and right front wheels 20 and 21 are expected to move. In another example, the expected vehicle trajectory may include four curves representing the paths through which the four corners of the vehicle 12 are expected to move.

Similarly, the expected trailer trajectory may include one or more points and/or a curve representing a path through which the trailer 14 is expected to move. For example, the expected vehicle trajectory may include two curves representing the paths through which the left and right wheels 42 and 43 are expected to move. In another example, the expected vehicle trajectory may include four curves representing the paths through which the four corners of the trailer 14 are expected to move.

The expected trajectory module 108 may determine the expected trajectories of the vehicle 12 and the trailer 14 when the vehicle 12 and the trailer 14 are moving forward. In this case, the expected vehicle trajectory may be referred to as an expected forward drive trajectory of the vehicle 12, and the expected trailer trajectory may be referred to as an expected forward drive trajectory of the trailer 14. The expected trajectory module 108 may also determine the expected vehicle trajectory and the expected trailer trajectory when the vehicle 12 and the trailer 14 are moving rearward.

The expected trajectory module 108 may determine the expected vehicle trajectory based on the steering angle of the vehicle 12 and/or one or more parameters of the vehicle 12. The vehicle parameters may include a current position of the vehicle 12, the speed of the vehicle 12, a wheelbase of the vehicle 12, a wheel track of the vehicle 12, and/or the distance 82 between the mass center 66 of the vehicle 12 and the rear axle 18. The expected trajectory module 108 may receive the current vehicle position from the environment mapping module 106. The expected trajectory module 108 may determine the speed of the vehicle 12 based on the wheel speed from the wheel speed sensor 49. The vehicle wheelbase, the vehicle wheel track, and the distance 82 may be predetermined and stored in the expected trajectory module 108.

The expected trajectory module 108 may determine one or more radii of turning paths that the vehicle 12 is expected to follow and determine the expected vehicle trajectory based on the radii. In one example, the expected trajectory module 108 determines the turning radius 68 of the mass center 66 of the vehicle 12 based on the distance 82, the wheelbase of the vehicle 12, and the steering angle of the vehicle 12 using a relationship such as

R=\sqrt{a₂²+l² cot² δ}, (2)

where R is the turning radius 68, a₂ is the distance 82, l is the wheelbase of the vehicle, and δ is the steering angle of the vehicle 12.

The expected trajectory module 108 may determine the expected trajectories of other points on the vehicle 12 based on predetermined geometric relationships between the mass center 66 and the other points. The other points may include the left front wheel 20, the right front wheel 21, and/or the four corners of the vehicle 12. In one example, the expected trajectory module 108 determines the turning radius of the left front wheel 20 based on the wheelbase of the vehicle 12, the steering angle of the vehicle 12, and the wheel track of the vehicle 12 using a relationship such as

$${R}_{i} = \sqrt{{l}^{2} + {( l cot δ - \frac{w}{2} )}^{2}} , \qquad ( 3 )$$

where Rᵢ is the turning radius of the left front wheel 20, l is the wheelbase of the vehicle 12, δ is the steering angle of the vehicle 12, and w is the wheel track of the vehicle 12.

In another example, the expected trajectory module 108 determines the turning radius of the right front wheel 21 based on the wheelbase of the vehicle 12, the steering angle of the vehicle 12, and the wheel track of the vehicle 12 using a relationship such as

$${R}_{o} = \sqrt{{l}^{2} + {( l cot δ + \frac{w}{2} )}^{2}} , \qquad ( 4 )$$

where Rₒ is the turning radius of the right front wheel 21, l is the wheelbase of the vehicle 12, δ is the steering angle of the vehicle 12, and w is the wheel track of the vehicle 12.

Relationships (3) and (4) may be used to determine the turning radii of the left and right front wheels 20 and 21, respectively, when the vehicle 12 is taking a left turn at shown in FIG. 1. However, when the vehicle 12 is taking a right turn, the relationships used to determine the turning radii of the left and right front wheels 20 and 21 may be switched. In other words, relationships (3) and (4) may be used to determine the turning radii of the right and left front wheels 21 and 20, respectively.

The expected trajectory module 108 may determine the expected trailer trajectory based on the steering angle of the vehicle 12, the hitch angle, one or more parameters of the vehicle 12, and/or one or more parameters of the trailer 14. The vehicle parameters may include the wheelbase of the vehicle 12, the wheel track of the vehicle 12, the current position of the vehicle 12, the speed of the vehicle 12, and/or the distance 84 between the rear axle 18 and the ball 28 of the trailer hitch 26. The trailer parameters may include a wheel track of the trailer 14 and/or the distance 86 between the distal end 46 of the tongue 44 and the axle 40 of the trailer 14. The trailer wheel track and the distances 84 and 86 may be predetermined.

The expected trajectory module 108 may determine one or more radii of turning paths that the trailer 14 is expected to follow and determine the expected trailer trajectory based on the radii. In one example, the expected trajectory module 108 determines the turning radius 72 of the longitudinal centerline 70 of the trailer 14 based on the distances 84 and 86, the wheelbase of the vehicle 12, the steering angle of the vehicle 12, and the hitch angle using a relationship such as

$${R}_{t} = {b}_{2} cot ( θ - {tan}^{- 1} ( \frac{{b}_{1}}{l cot δ} ) ) , \qquad ( 5 )$$

where Rₜ is the turning radius 72, b₁ is the distance 84, b₂ is the distance 86, l is the wheelbase of the vehicle 12, δ is the steering angle of the vehicle 12, and θ is the hitch angle.

In another example, the expected trajectory module 108 determines the turning radius 72 based on the vehicle wheelbase, the steering angle 62 of the left front wheel 20, the vehicle wheel track, and the distances 84 and 86 using a relationship such as

$${R}_{t} = \sqrt{{( l cot {δ}_{i} + \frac{1}{2} w )}^{2} + {b}_{1}^{2} - {b}_{2}^{2}} , \qquad ( 6 )$$

where Rₜ is the turning radius 72, l is the vehicle wheelbase, δᵢ is the steering angle 62 of the left front wheel 20, w is the vehicle wheel track, b₁ is the distance 84, and b₂ is the distance 86.

The expected trajectory module 108 may determine the expected trajectories of other points on the trailer 14 based on predetermined geometric relationships between the longitudinal centerline 70 and the other points. The other points may include the left wheel 42, the right wheel 43, and/or the four corners of the trailer 14. The driver may use the user interface device 60 to provide the dimensions of the trailer 14, and the expected trajectory module 108 may determine the geometric relationships between the longitudinal centerline 70 and the four corners of the trailer 14 based thereon. In one example, the expected trajectory module 108 determines the turning radius of the left wheel 42 by subtracting one-half of the trailer wheel track from turning radius 72. In another example, the expected trajectory module 108 determines the turning radius of the right wheel 43 by adding one-half of the vehicle wheel track to the turning radius 72.

The user interface device 60 displays one or more of the images captured by the cameras 50-56 and/or the top view generated by the environment mapping module 106. In addition, the user interface device 60 may display the expected trajectories of the vehicle 12 and the trailer 14. The user interface device 60 may do this by overlaying the expected trajectories of the vehicle 12 and the trailer 14 onto one or more of the images from the cameras 50-56 and/or the top view generated by the environment mapping module 106.

The jackknifing identification module 110 identifies when the vehicle 12 and the trailer 14 are likely to jackknife based on the expected trajectories of the vehicle 12 and the trailer 14. The jackknifing identification module 110 may identify that the vehicle 12 and the trailer 14 are likely to jackknife when the expected trajectories of the vehicle 12 and the trailer 14 indicate that any portion of the trailer 14 other than the tongue 44 will contact the vehicle 12. For example, the jackknifing identification module 110 may identify that the vehicle 12 and the trailer 14 are likely to jackknife when the expected trajectories of the vehicle 12 and the trailer 14 indicate that the body 38 of the trailer 14 will contact a rear bumper of the vehicle 12. The rear bumper may be part of the body 15 of the vehicle.

The user interface device 60 displays a jackknifing warning when the jackknifing identification module 110 identifies that the vehicle 12 and the trailer 14 are likely to jackknife. The jackknifing warning indicates that the vehicle 12 and the trailer 14 are likely to jackknife. The jackknifing warning may include text such as “jackknife imminent” and a symbol such as an exclamation mark.

The example implementation of the control module 58 shown in FIG. 2 further includes a turn identification module 112, a target steering angle module 114, a target trajectory module 116, and a steering control module 118. The turn identification module 112 identifies when the vehicle 12 is going to make a turn. The turn identification module 112 may identify when the vehicle 12 is going to make a turn based on the position of the vehicle 12 and a predetermined route of the vehicle 12. For example, the turn identification module 112 may identify that the vehicle 12 is going to make a turn when the vehicle position indicate that the vehicle 12 is approaching an intersection and the predetermined route includes a turn at that intersection. The driver may use the user interface device 60 to upload the predetermined route to the turn identification module 112 before making a trip.

Additionally or alternatively, the turn identification module 112 may identify when the vehicle 12 is going to make a turn based on the position of the vehicle 12 and a position of a turn signal switch. For example, the turn identification module 112 may identify that the vehicle 12 is going to make a turn when the vehicle position indicate that the vehicle 12 is approaching an intersection and the turn signal switch is on. The turn signal switch may be part of or separate from the user interface device 60.

The target steering angle module 114 determines a target steering angle of the vehicle 12 during a turn and outputs the target steering angle. The target steering angle module 114 may determine the target steering angle when the turn identification module 112 identifies that the vehicle 12 is going to make the turn. The target steering angle module 114 may determine the target steering angle based on the expected trajectories of the vehicle 12 and the trailer 14, the outer lane boundary 88 that extends along the first and second roads 90 and 92, and the centerline 94 of the second road 92.

When determining the expected trajectories for use in determining the target steering angle, the expected trajectory module 108 may determine the expected trajectories based on a possible steering angle for the turn instead of the current steering angle. If the expected trajectories satisfy predetermined criteria, the target steering angle module 114 may set the target steering angle equal to the possible steering angle. Otherwise, the expected trajectory module 108 may select another possible steering angle, and the target steering angle module 114 may determine whether that possible steering angle satisfies the predetermined criteria.

The target steering angle module 114 may determine the target steering angle based on a relationship between the expected trajectory of the trailer 14 and the outer lane boundary 88. For example, referring briefly to FIG. 11, an expected trajectory 120 of the left front wheel 20 and an expected trajectory 122 of the right front wheel 21 are shown as the vehicle 12 makes a right turn from the first road 90 to the second road 92. The target steering angle module 114 may determine the target steering angle based on a distance 124 between the expected trajectory 122 and the outer lane boundary 88.

The target steering angle module 114 may determine the target steering angle based on a relationship between the expected trajectory of the vehicle 12 and the centerline 94. For example, referring briefly to FIG. 12, an expected trajectory 126 of the left wheel 42 and an expected trajectory 128 of the right wheel 43 are shown as the trailer 14 makes a right turn from the first road 90 to the second road 92. The target steering angle module 114 may determine the target steering angle based on a distance 130 between the expected trajectory 126 and the centerline 94.

The target steering angle module 114 may determine the target steering angle in a way that maximizes the distances 124 and 130. For example, the target steering angle module 114 may determine the target steering angle using a relationship such as

I=max{∫ₜ₁^{t2}[W₁(Sᵥ(t)−Sᵥ^{infra})²+W₂(Sₜᵣ(t)−Sₜᵣ^{infra})²]dt}, (7)

where I is a cost of a possible steering angle, Sᵥ(t) is the expected vehicle trajectory for the possible steering angle as a function of time t, Sᵥ^{infra} is the centerline 94, and W₁ is a weighting value associated with a difference between the expected vehicle trajectory and the centerline 94. Similarly, Sₜᵣ(t) is the expected trailer trajectory for the possible steering angle as a function of time t, Sₜᵣ^{infra} is the outer lane boundary 88, and W₂ is a weighting value associated with a difference between the expected trailer trajectory and the centerline 94.

The target steering angle module 114 determines the cost of the possible steering angle by integrating the right side of relationship (7) with respect to time. More specifically, the target steering angle module 114 determines the cost of the possible steering angle by performing the integration over a period from a time t1 to a time t2. The target steering angle module 114 then determines whether the possible steering angle maximizes the cost for that period. If the possible steering angle maximizes the cost for that period, the target steering angle module 114 sets the target steering angle for that period equal to the possible steering angle. Otherwise, the expected trajectory module 108 selects another possible steering angle, and the target steering angle module 114 determine whether that possible steering angle maximizes the cost. Thus, the target steering angle module 114 may determine the target steering angle in an iterative manner. The target steering angle module 114 may determine the target steering angle using relationship (7) and an iterative problem solving approach such as the Hamilton-Jacobi-Bellman equation. The expected trajectory module 108 may initially select a possible steering angle that achieves a vehicle turning radius that is offset from the outer lane boundary 88, and then adjust the possible steering angle incrementally as iterations are performed.

The target steering angle module 114 may determine the target steering angle in the manner described above for a plurality of periods within an overall period that it takes the vehicle 12 and the trailer 14 to complete the turn. In one example, each period may be a few milliseconds. As a result, the target steering angle module 114 may generate a plurality of target steering angles corresponding to a plurality of periods within an overall period of a single turn.

The target trajectory module 116 determines a target trajectory of the vehicle 12 based on the target steering angle and outputs the target vehicle trajectory. The target trajectory module 116 may determine the target vehicle trajectory in the same manner that the expected trajectory module 108 determines the expected vehicle trajectory. However, instead of using the current steering angle or a possible steering angle, the target trajectory module 116 may use the target steering angle to determine the target vehicle trajectory. The target vehicle trajectory may include one or more points and/or a curve representing a target path for one or more points on the vehicle 12. In one example, the target vehicle trajectory includes a curve representing a target path for a point midway between the left and right front wheels 20 and 21. The target trajectory module 116 may adjust the target vehicle trajectory to avoid any obstacles in the path of the vehicle 12 and/or the trailer 14.

The user interface device 60 displays the target vehicle trajectory by, for example, overlaying the target vehicle trajectory on the image captured by the front camera 50 and/or the top view generated by the environment mapping module 106. In various implementations, the control module 58 may include a target steering wheel position module (not shown) that determines a target steering wheel position, and the user interface device 60 may display the target steering wheel position. The target steering wheel position module may determine the target steering wheel position based on the target steering angle using, for example, a predetermined relationship between the steering wheel position and the steering angle.

The steering control module 118 may control the steering actuator 36 based on the actual position of the steering wheel 30 when the steering system 24 is a steer-by-wire system. Additionally or alternatively, the steering control module 118 may control the steering actuator 36 based on the target steering angle. The steering control module 118 may control the steering actuator 36 based on the target steering angle instead of or in addition to the user interface device 60 displaying the target vehicle trajectory and/or the target steering wheel position. When the steering control module 118 controls the steering actuator 36 based on the target steering angle, the driver may control a throttle (not shown) of the vehicle 12 and brakes (not shown) of the vehicle 12.

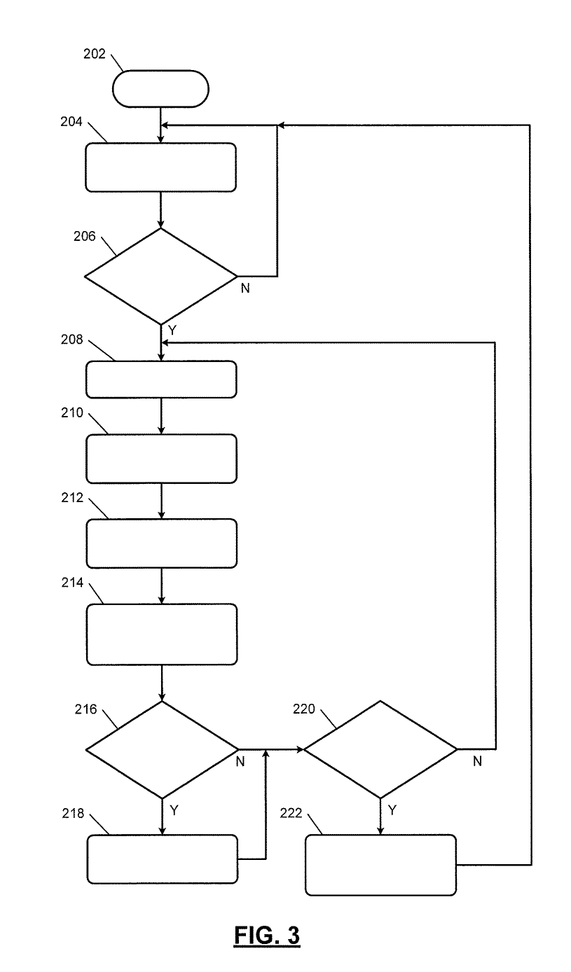

Referring now to FIG. 3, a method for displaying forward drive trajectories of a vehicle and a trailer and providing a jackknifing warning begins at 202. The method is described in the context of the modules of FIG. 2. However, the particular modules that perform the steps of the method may be different than the modules mentioned below and/or the method may be implemented apart from the modules of FIG. 2.

At 204, the actual steering angle module 102 determines the actual steering angle of the vehicle 12. At 206, the turn identification module 112 determines whether the vehicle 12 is making a turn while moving forward. If the vehicle 12 is making a turn while moving forward, the method continues at 208. Otherwise, the method returns to 204.

The turn identification module 112 may determine that the vehicle 12 is making a turn when the steering angle is greater than a predetermined angle. The turn identification module 112 may determine whether the vehicle is moving forward based on the wheel speed from the wheel speed sensor 49 and/or the position of a shift lever. For example, the turn identification module 112 may determine that the vehicle is moving forward when the wheel speed is greater than a predetermined speed and the shift lever is in a forward gear position. The shift lever may be part of or separate from the user interface device 60.

At 208, the hitch angle module 104 determines the hitch angle. At 210, the expected trajectory module 108 determines the expected trajectory of the vehicle 12. At 212, the expected trajectory module 108 determines the expected trajectory of the trailer 14. At 214, the user interface device 60 displays the expected trajectories of the vehicle 12 and the trailer 14.

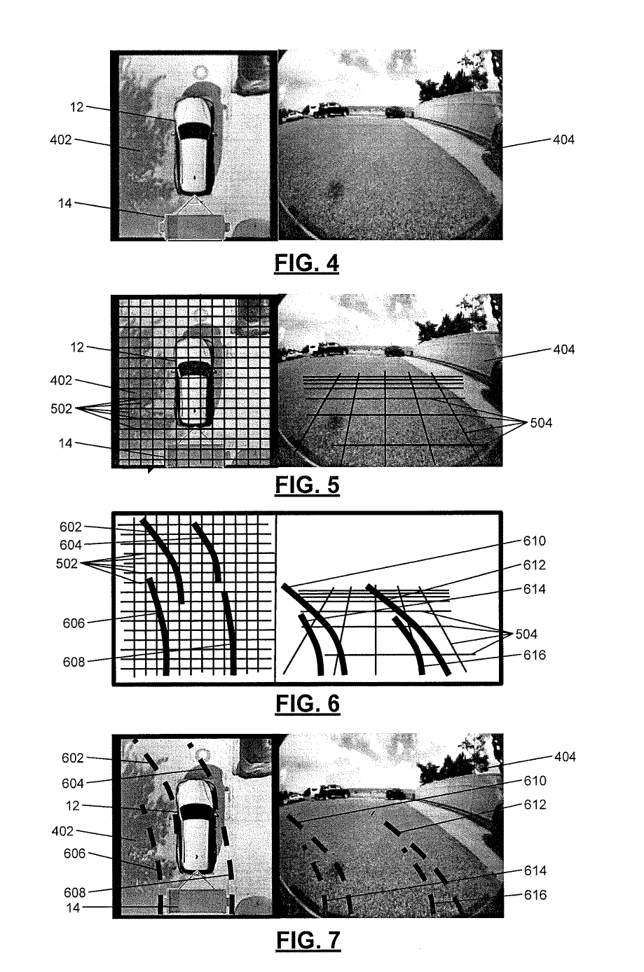

As discussed above, the user interface device 60 may overlay the expected trajectories of the vehicle 12 and the trailer 14 onto the image captured by the front camera 50 and/or the top view generated by the environment mapping module 106. Referring briefly to FIGS. 4-7, an overview of the process will now be explained. FIG. 4 shows an example of a top view 402 of the vehicle 12 and the trailer 14 generated by the environment mapping module 106, and an example of an image 404 captured by the front camera 50.

FIG. 5 shows an example of a first set of gridlines 502 representing the road surface in the top view 402, and an example of a second set of gridlines 504 representing the road surface in the image 404. FIG. 6 shows an example trajectory 602 of the left front wheel 20, an example trajectory 604 of the right front wheel 21, an example trajectory 606 of the left wheel 42, and an example trajectory 608 of the right wheel 43. The user interface device 60 plots the example trajectories 602-608 relative to the first set of gridlines 502. FIG. 6 also shows an example trajectory 610 of the left front wheel 20, an example trajectory 612 of the right front wheel 21, an example trajectory 614 of the left wheel 42, and an example trajectory 616 of the right wheel 43. The user interface device 60 plots the example trajectories 610-616 relative to the second set of gridlines 504.

FIG. 7 shows the trajectories 602-608 overlaid onto the top view 402 and the trajectories 610-616 overlaid onto the image 404. The trajectories 610-616 correspond to the trajectories 602-608, respectively. However, the trajectories 610-616 appear differently to account for the different perspectives shown in the top view 402 and the image 404. The gridlines 502 and 504 enable the user interface device 60 to adjust the appearance of the trajectories 602-616 based on the different perspectives shown in the top view 402 and the image 404.

Referring again to FIG. 3, at 216, the jackknifing identification module 110 determines whether the vehicle 12 and the trailer 14 are likely to jackknife. If the vehicle 12 and the trailer 14 are likely to jackknife, the user interface device 60 displays the jackknifing warning at 218 and then the method continues at 220. Otherwise, the method continues directly to 220.

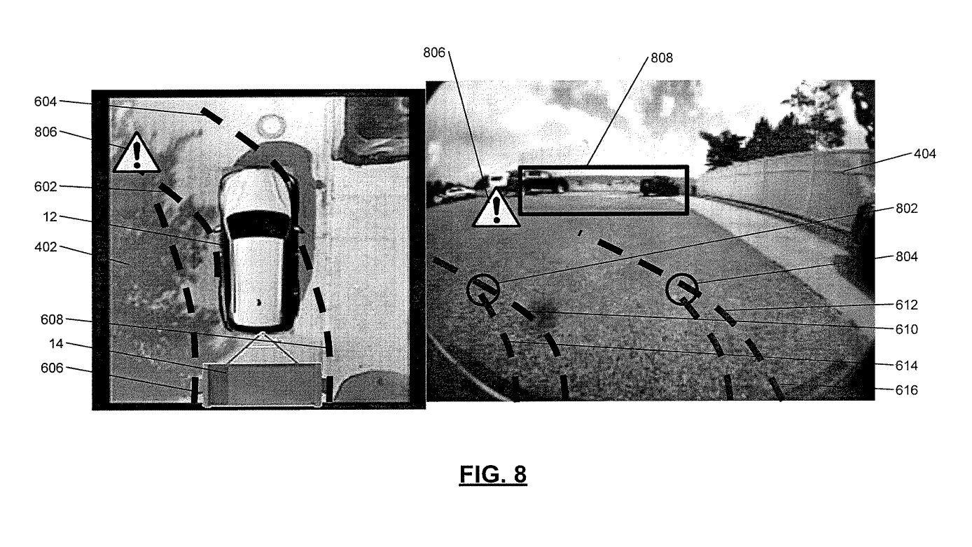

Referring briefly to FIG. 8, the jackknifing identification module 110 may determine that the vehicle 12 and the trailer 14 are likely to jackknife when the trailer left wheel trajectory intersects the vehicle left front wheel trajectory as indicated at 802. In addition, the jackknifing identification module 110 may determine that the vehicle 12 and the trailer 14 are likely to jackknife when the trailer right wheel trajectory intersects the vehicle right front wheel trajectory as indicated at 804.

Further, an example of a jackknifing warning includes a symbol 806 and a text box 808. The symbol 806 may include an exclamation mark as shown, and the text box 808 may include text such as “jackknife imminent.” The user interface device 60 overlaid the symbol 806 onto the top view 402, and overlaid the symbol 806 and the text box 808 onto the image 404.

Referring again to FIG. 3, at 220, the turn identification module 112 determines whether the vehicle 12 and the trailer 14 have competed the turn. The turn identification module 112 may determine that the vehicle 12 and the trailer 14 have competed the turn when the steering angle is less than a predetermined angle. If the vehicle 12 and the trailer 14 have competed the turn, the method continues at 222. At 222, the user interface device 60 stops displaying the expected trajectories of the vehicle 12 and the trailer 14. Also, at 222, the user interface device 60 may stop displaying the top view generated by the environment mapping module 106 and the view captured by the front camera 50. If the vehicle 12 and the trailer 14 have not competed the turn, the method returns to 208. Before the method returns to 208, the actual steering angle module 102 may determine the actual steering angle of the vehicle 12 once again.

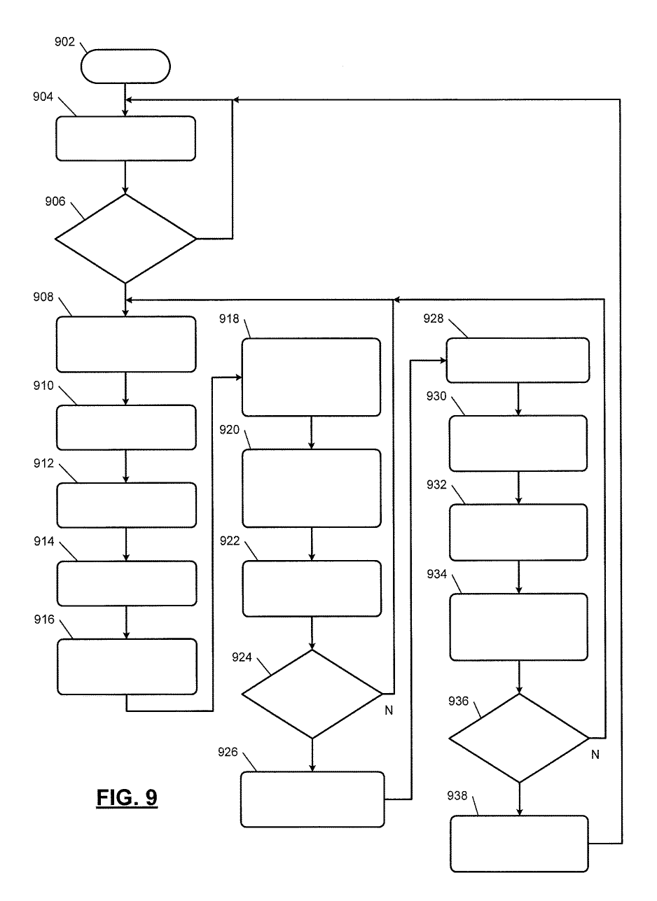

Referring now to FIG. 9, an example method for providing a turn aid for a driver of a vehicle towing a trailer begins at 902. The method is described in the context of the modules of FIG. 2. However, the particular modules that perform the steps of the method may be different than the modules mentioned below and/or the method may be implemented apart from the modules of FIG. 2.

At 904, the environment mapping module 106 determines the position of the vehicle 12. At 906, the turn identification module 112 determines whether the vehicle 12 is going to make a turn. If the vehicle 12 is going to make a turn, the method continues at 908. Otherwise, the method returns to 904.

At 908, the expected trajectory module 108 selects a possible steering angle of the vehicle 12 during the turn. At 910, the expected trajectory module 108 determines the expected trajectory of the vehicle 12. At 912, the expected trajectory module 108 determines the expected trajectory of the trailer 14. At 914, the environment mapping module 106 determines the road parameters. At 916, the environment mapping module 106 identifies any objects or obstacles in the expected trajectories of the vehicle 12 and the trailer 14.

At 918, the target steering angle module 114 determines the distance 124 between the expected trajectory 122 and the outer lane boundary 88. The distance 124 may be the minimum distance between the expected trajectory 122 and the outer lane boundary 88 as shown in FIG. 11. At 920, the target steering angle module 114 determines the distance 130 between the expected trajectory 126 and the centerline 94. The distance 130 may be the minimum distance between the expected trajectory 126 and the centerline 94 as shown in FIG. 12.

At 922, the target steering angle module 114 determines the cost of the possible steering angle using relationship (7). At 924, the target steering angle module 114 determines whether the possible steering angle maximizes the cost. If the possible steering angle maximizes the cost, the method continues at 926. Otherwise, the method continues at 928.

At 928, the target trajectory module 116 determines the target vehicle trajectory. At 930, the steering wheel position module determines the target steering wheel position. At 932, the user interface device 60 guides the driver through the turn based on the target vehicle trajectory.

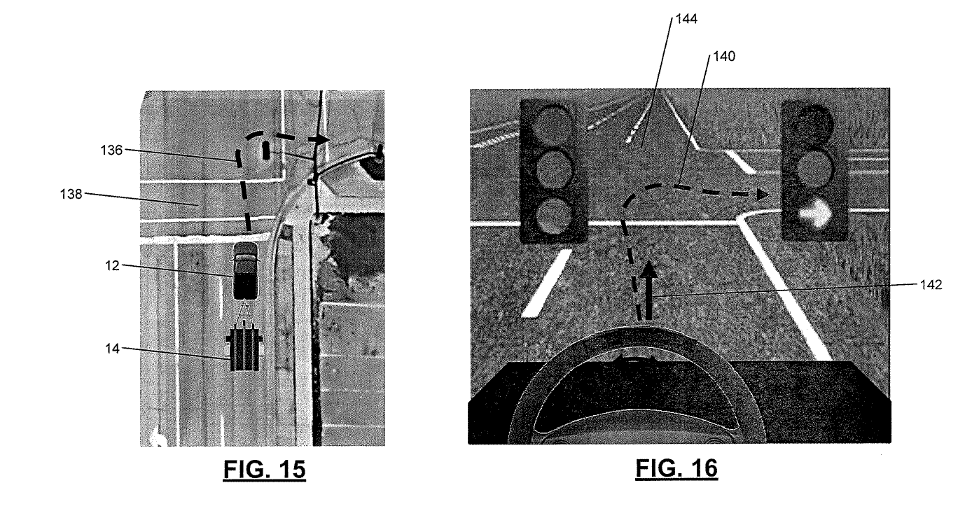

Referring briefly to FIG. 13, the user interface device 60 may guide the driver through the turn by displaying an arrow 132 indicating the direction in which the vehicle 12 should move in order to follow the target vehicle trajectory. The user interface device 60 may display the arrow 132 in a top view 134 of the vehicle 12 and the trailer 14. Additionally or alternatively, briefly referring to FIG. 15, the user interface device 60 may display a curve 136 representing the target vehicle trajectory in a top view 138 of the vehicle 12 and the trailer 14. Additionally or alternatively, briefly referring to FIG. 16, the user interface device 60 may display a curve 140 representing the target vehicle trajectory and/or an arrow 142 representing the target steering wheel position. The user interface device 60 may display the curve 140 and/or the arrow 142 on a windshield 144 of the vehicle 12, in which case the user interface device 60 may include a projector.

At 934, the steering control module 118 controls the steering actuator 36 based on the target steering angle. At 936, the turn identification module 112 determines whether the turn is complete. The turn identification module 112 may determine whether the turn is complete based on the position of the vehicle 12. For example, referring briefly to FIG. 14, the turn identification module 112 may determine that the turn is complete when the vehicle position indicates that the vehicle 12 and the trailer 14 are on the second road 92 as shown. If the turn is complete, the method continues at 938. Otherwise, the method returns to 908 and the expected trajectory module 108 selects another possible steering angle. Before returning to 908, the environment mapping module 106 may determine the actual position of the vehicle 12 once again.

At 938, the user interface device 60 stops guiding the driver through the turn based on the target steering angle and the steering control module 118 stops controlling the steering actuator 36 based on the target steering angle. Also, at 938, the user interface device 60 may stop displaying the top view generated by the environment mapping module 106 and the view captured by the front camera 50.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A system comprising:
an expected trajectory module that:
determines an expected forward drive trajectory of a vehicle; and
determines an expected forward drive trajectory of a trailer being towed by the vehicle; and
an electronic display that displays the expected forward drive trajectories of the vehicle and the trailer.

2. The system of claim 1 wherein:
the expected trajectory module determines the expected forward drive trajectory of the vehicle at a future time based on a steering angle at a current time and a vehicle parameter; and
the expected trajectory module determines the expected forward drive trajectory of the trailer at the future time based on a hitch angle at the current time and a trailer parameter, wherein the hitch angle is an angle between a longitudinal centerline of the vehicle and a longitudinal centerline of the trailer.

3. The system of claim 2 wherein:
the vehicle parameter includes a first distance from a mass center of the vehicle to a rear axle of the vehicle and a wheelbase of the vehicle; and
the trailer parameter includes a second distance from a hitch of the trailer to a rear axle of the trailer.

4. The system of claim 1 further comprising a jackknifing identification module that identifies when the trailer and the vehicle are likely to jackknife based on the expected forward drive trajectories of the vehicle and the trailer, wherein the electronic display displays a jackknifing warning when the trailer and the vehicle are likely to jackknife.

5. A system comprising:
an expected trajectory module that:
determines an expected trajectory of a vehicle; and
determines an expected trajectory of a trailer being towed by the vehicle;
a target trajectory module that determines a target trajectory of the vehicle during a turn based on the expected vehicle trajectory, the expected trailer trajectory, and at least one road parameter; and
at least one of:
a user interface device that guides a driver of the vehicle through the turn based on the target vehicle trajectory; and
a steering control module that controls a steering actuator of the vehicle based on the target vehicle trajectory.

6. The system of claim 5 further comprising a target steering angle module that determines a target steering angle of the vehicle during the turn based on the expected vehicle trajectory, the expected trailer trajectory, and the road parameter, wherein the target trajectory module determines the target vehicle trajectory based on the target steering angle.

7. The system of claim 6 wherein:
the target steering angle module determines the target steering angle when the vehicle is turning from a first road to a second road intersecting the first road; and
the at least one road parameter includes an outer lane boundary that extends alongside the first and second roads and a centerline of the second road.

8. The system of claim 7 wherein the target steering angle module determines the target steering angle based on:
a first distance between the expected trailer trajectory and the outer lane boundary; and
a second distance between the expected vehicle trajectory and the centerline of the second road.

9. The system of claim 8 wherein:
the expected trajectory module determines the expected vehicle trajectory based on a possible steering angle of the vehicle during the turn; and
the target steering angle module selectively sets the target steering angle equal to the possible steering angle based on the first and second distances.

10. The system of claim 5 further comprising a turn identification module that identifies when the vehicle is going to make the turn based on at least one of a predetermined route, a position of the vehicle, and a position of a turn signal switch.

11. A method comprising:
determining an expected forward drive trajectory of a vehicle;
determining an expected forward drive trajectory of a trailer being towed by the vehicle; and
displaying the expected forward drive trajectories of the vehicle and the trailer using an electronic display.

12. The method of claim 11 wherein:
determining the expected forward drive trajectory of the vehicle at a future time based on a steering angle at a current time and a vehicle parameter; and
determining the expected forward drive trajectory of the trailer at the future time based on a hitch angle at the current time and a trailer parameter, wherein the hitch angle is an angle between a longitudinal centerline of the vehicle and a longitudinal centerline of the trailer.

13. The method of claim 12 wherein:
the vehicle parameter includes a first distance from a mass center of the vehicle to a rear axle of the vehicle and a wheelbase of the vehicle; and
the trailer parameter includes a second distance from a hitch of the trailer to a rear axle of the trailer.

14. The method of claim 11 further comprising:
identifying when the trailer and the vehicle are likely to jackknife based on the expected forward drive trajectories of the vehicle and the trailer; and
displaying a jackknifing warning using the electronic display when the trailer and the vehicle are likely to jackknife.

15. A method comprising:
determining an expected trajectory of a vehicle;
determines an expected trajectory of a trailer being towed by the vehicle;
determining a target trajectory of the vehicle during a turn based on the expected vehicle trajectory, the expected trailer trajectory, and at least one road parameter; and
at least one of:
guiding a driver of the vehicle through the turn based on the target vehicle trajectory; and
controlling a steering actuator of the vehicle based on the target vehicle trajectory.

16. The method of claim 15 further comprising:
determining a target steering angle of the vehicle during the turn based on the expected vehicle trajectory, the expected trailer trajectory, and the road parameter; and
determining the target vehicle trajectory based on the target steering angle.

17. The method of claim 16 further comprising determining the target steering angle when the vehicle is turning from a first road to a second road intersecting the first road, wherein the at least one road parameter includes an outer lane boundary that extends alongside the first and second roads and a centerline of the second road.

18. The method of claim 17 further comprising determining the target steering angle based on:
a first distance between the expected trailer trajectory and the outer lane boundary; and
a second distance between the expected vehicle trajectory and the centerline of the second road.

19. The method of claim 18 further comprising:
determining the expected vehicle trajectory based on a possible steering angle of the vehicle during the turn; and
selectively setting the target steering angle equal to the possible steering angle based on the first and second distances.

20. The method of claim 15 further comprising identifying when the vehicle is going to make the turn based on at least one of a predetermined route, a position of the vehicle, and a position of a turn signal switch.
